(19) United States
(12) Patent Application Publication
(10) Pub. No.: US 2024/0185404 A1
(43) Pub. Date: Jun. 6, 2024

(54) INFORMATION PROCESSING DEVICE

(71) Applicant: TOYOTA JIDOSHA KABUSHIKI KAISHA, Toyota-shi (JP)

(72) Inventors: Shusuke YAMAMOTO, Tokyo (JP); Chikara OKAZAKI, Gotemba-shi (JP); Kohta WATATSU, Nagoya-shi (JP); Hideyuki TANAKA, Nisshin-shi (JP); Shinya MURASE, Nagoya-shi (JP); Tatsuya OBUCHI, Obu-shi (JP); Yuki TATSUMOTO, Seto-shi (JP)

(73) Assignee: TOYOTA JIDOSHA KABUSHIKI KAISHA, Toyota-shi (JP)

(21) Appl. No.: 18/387,940

(22) Filed: Nov. 8, 2023

(30) Foreign Application Priority Data
Dec. 6, 2022 (JP) 2022-195225

(51) Int. Cl. G06T 7/00; G06V 20/10; G06V 20/13

(52) U.S. Cl. CPC G06T 7/0002; G06V 20/13; G06V 20/182; G06T 2207/10032; G06T 2207/30181; G06T 2207/30236; G06V 2201/08

(57) ABSTRACT

An information processing device includes a satellite image acquisition section, a vehicle extraction section, an analysis section, and a prediction section. The satellite image acquisition section acquires a satellite image. The vehicle extraction section extracts large-sized vehicles, which have a size equal to or greater than a predetermined value, from the satellite image acquired by the satellite image acquisition section. The analysis section detects, in the satellite image, a road on which travel of the large-sized vehicles is equal to or greater than a predetermined value, and analyzes vehicle data for the detected road. The prediction section predicts a state of deterioration of a surface of the road based on an analysis result by the analysis section.

### CROSS-REFERENCE TO RELATED APPLICATION

This application is based on and claims priority under 35 USC § 119 from Japanese Patent Application No. 2022-195225 filed on Dec. 6, 2022, the disclosure of which is incorporated by reference herein.

### BACKGROUND

### Technical Field

The present disclosure relates to an information processing device.

### Related Art

It is known that as the number of large-sized vehicles that are traveling increases, road surface deterioration accelerates and the lifespan of a road shortens. Japanese Patent Application Laid-Open (JP-A) No. 2003-288665 (Patent Document 1) discloses a method of estimating an amount of large-sized vehicle traffic based on data from a traffic sensor to predict road surface properties.

Since the method disclosed in Patent Document 1 estimates the amount of large-sized vehicle traffic, in a case in which a difference arises between the estimated amount and the actual amount of large-sized vehicle traffic, the accuracy of the predicted value is reduced.

### SUMMARY

In consideration of the above facts, an object of the present disclosure is to provide an information processing device capable of accurately predicting a state of deterioration of a surface of a road, and of increasing a lifespan of a road and reducing a road budget.

An information processing device according to a first aspect of the present disclosure includes: a satellite image acquisition section that is configured to acquire a satellite image; a vehicle extraction section that is configured to extract large-sized vehicles, which have a size equal to or greater than a predetermined value, from the satellite image acquired by the satellite image acquisition section; an analysis section that is configured to detect, in the satellite image, a road on which travel of the large-sized vehicles is equal to or greater than a predetermined value, and to analyze vehicle data for the road; and a prediction section that is configured to predict a state of deterioration of a surface of the road based on an analysis result by the analysis section.

In the information processing device according to the first aspect, large-sized vehicles having a size equal to or greater than a predetermined value are extracted from a satellite image, and a road on which travel of the large-sized vehicles is equal to or greater than a predetermined value is detected. This enables the number of large-sized vehicles actually traveling on a road to be understood from the satellite image. Moreover, the information processing device according to the first aspect of the present disclosure analyzes vehicle data for a road on which travel of large-sized vehicles is equal to or greater than a predetermined value, and predicts a state of deterioration of a surface of the road based on the analysis result. As a result, since the state of deterioration of a surface of a road can be predicted based on vehicle data for a road on which the actual travel amount of large-sized vehicles is large, the state of deterioration of the surface of the road can be predicted accurately. Moreover, since the state of deterioration of the surface of the road can be accurately predicted, the infrastructure and life-cycle cost of the road can be optimized, thereby enabling the lifespan of the road to be extended and the budget for the road to be reduced.

An information processing device according to a second aspect of the present disclosure is the information processing device according to the first aspect, wherein: the satellite image acquisition section is configured to acquire weather information associated with the acquired satellite image; and based on the acquired weather information, the satellite image acquisition section is configured to acquire a satellite image captured on a clear-weather day.

In the information processing device according to the second aspect, since a satellite image captured on a clear-weather day is acquired, a clearer satellite image can be acquired. As a result, since large-sized vehicles can be easily extracted from the acquired satellite image, the state of deterioration of the surface of the road can be predicted more accurately.

An information processing device according to a third aspect of the present disclosure is the information processing device according to the first aspect or the second aspect, wherein: the satellite image acquisition section is configured to acquire weather information associated with the acquired satellite image; and the prediction section is configured to apply, to a predicted state of deterioration of the surface of the road, a weighting according to weather based on the weather information acquired by the satellite image acquisition section.

For example, since a satellite image captured on a clear-weather day has a high intensity of illumination compared to a satellite image captured in rainy weather or cloudy weather, it is easier to extract large-sized vehicles than for a satellite image captured in rainy weather or cloudy weather. On the other hand, since a satellite image captured in the evening of rainy weather, cloudy weather, and the like has a low intensity of illumination compared to a satellite image captured on a clear-weather day, it is more difficult to extract large-sized vehicles than for a satellite image captured on a clear-weather day. Accordingly, in the information processing device according to the third aspect of the present disclosure, a weighting according to weather based on the weather information associated with the satellite image is applied to a predicted state of deterioration of the surface of the road. This enables the reliability of extraction of large-sized vehicles in the satellite image to be reflected in the predicted state of deterioration of the surface of the road, thereby enabling the state of deterioration of the surface of the road to be predicted more accurately.

An information processing device according to a fourth aspect of the present disclosure is the information processing device according to any one of the first aspect to the third aspect, wherein: the vehicle extraction section is configured to extract, as the large-sized vehicles, at least one of trucks, buses, or vehicles having a predetermined weight or greater.

In the information processing device according to the fourth aspect, at least one of trucks, buses, or vehicles having a predetermined weight or greater are extracted as the large-sized vehicles. Accordingly, in a case in which a vehicle having a predetermined weight or greater is extracted as a large-sized vehicle, for example, even a vehicle of a relatively small size, a vehicle loaded with more baggage is also extracted as a large-sized vehicle. For this reason, vehicles with heavy weight, which are considered to affect deterioration of a surface of a road, can also be reflected in the prediction of the state of deterioration of the surface of the road.

An information processing device according to a fifth aspect of the present disclosure is the information processing device according to any one of the first aspect to the fourth aspect, wherein: the information processing device further includes an operating day acquisition section that is configured to acquire, from a business that operates large-sized vehicles, data indicating operating days of the business; and the satellite image acquisition section is configured to acquire a satellite image captured on an operating day of the business which is included in the data acquired by the operating day acquisition section.

In the information processing device according to the fifth aspect, a satellite image captured on an operating day of a business that operates large-sized vehicles is acquired. This enables the satellite image captured on the day on which the large-sized vehicles actually travel to be acquired, enabling the state of deterioration of the surface of the road to be predicted more accurately.

As described above, the information processing device according to the present disclosure is capable of accurately predicting a state of deterioration of a surface of a road, and of increasing a lifespan of a road and reducing a road budget.

### BRIEF DESCRIPTION OF THE DRAWINGS

FIG. 1 is a diagram illustrating an example of a schematic configuration of an information processing system according to a first exemplary embodiment of the present disclosure.

FIG. 2 is a block diagram illustrating a hardware configuration of a user terminal according to a first exemplary embodiment of the present disclosure.

FIG. 3 is a block diagram illustrating a hardware configuration of a center server according to a first exemplary embodiment of the present disclosure.

FIG. 4 is a block diagram illustrating an example of a functional configuration of a CPU in a center server according to a first exemplary embodiment of the present disclosure.

FIG. 5 is a flowchart illustrating an example of a flow of information processing according to a first exemplary embodiment of the present disclosure.

FIG. 6 is a block diagram illustrating an example of a functional configuration of a CPU in a center server according to a second exemplary embodiment of the present disclosure.

FIG. 7 is a flowchart illustrating an example of a flow of information processing according to a second exemplary embodiment of the present disclosure.

### DETAILED DESCRIPTION

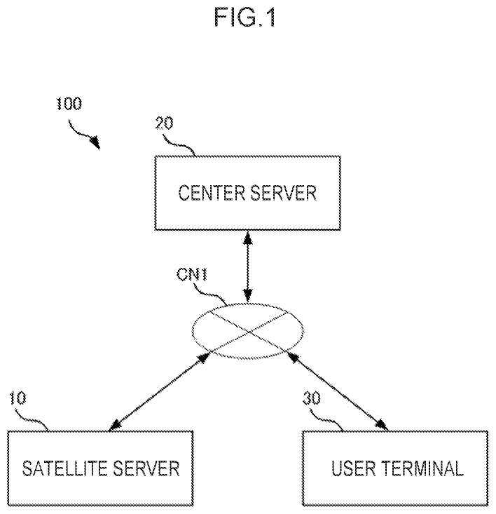

Explanation follows regarding an information processing system 100 according to a first exemplary embodiment of the present disclosure, with reference to the accompanying drawings. As illustrated in FIG. 1, the information processing system 100 of the present exemplary embodiment includes a satellite server 10, a center server 20, and a user terminal 30. The center server 20 is an example of an information processing device. Note that the number of user terminals 30 included in the information processing system 100 is not limited to the number illustrated in FIG. 1. The satellite server 10, the center server 20, and the user terminal 30 are connected to each other via a network CN1.

The satellite server 10 accumulates satellite images, which are terrestrial images captured from above by an artificial satellite, an aircraft, or the like. More specifically, the satellite server 10 associates and accumulates the satellite images, the date and time when the satellite images were captured, weather information on the day on which the satellite images were captured, and the location at which the satellite images were captured. Note that the “weather information” includes information such as intensity of illumination and the presence or absence of precipitation, and specifically includes information that distinguishes between clear weather, rainy weather, and cloudy weather, for example.

### User Terminal

The user terminal 30 is a terminal such as a smartphone or a computer possessed by a user.

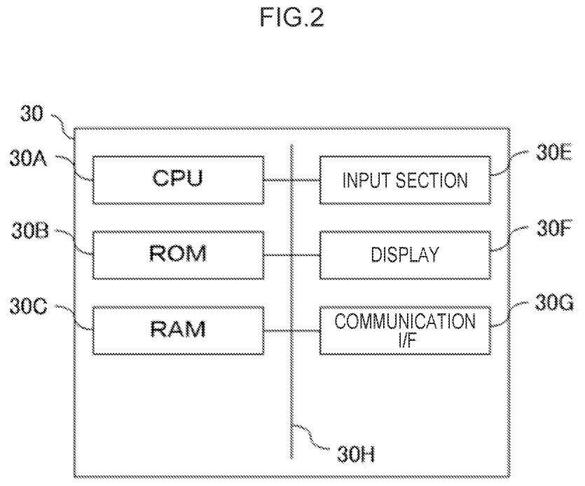

As illustrated in FIG. 2, the user terminal 30 includes a central processing unit (CPU) 30A, read only memory (ROM) 30B, random access memory (RAM) 30C, an input section 30E, a display 30F, and a communication interface (I/F) 30G. The CPU 30A, the ROM 30B, the RAM 30C, the input section 30E, the display 30F, and the communication I/F 30G are connected so as to be capable of communicating with each other via an internal bus 30H. Note that the user terminal 30 may include non-volatile memory such as an SD card, in addition to the ROM 30B.

The CPU 30A is a central processing unit that executes various programs and controls various components. Namely, the CPU 30A reads a program from the ROM 30B, and executes the program using the RAM 30C as a workspace.

The ROM 30B stores various programs and various data. The RAM 30C serves as a workspace to temporarily store programs and data.

The input section 30E is, for example, a keyboard, a push-button numeric keypad or a touch pad, and is used to input various information using a user's finger.

The display 30F is, for example, a liquid crystal display, and displays various information. The display 30F may be provided as a touch display also serving as the input section 30E.

The communication I/F 20G is an interface for connecting to the network CN1.

### Center Server

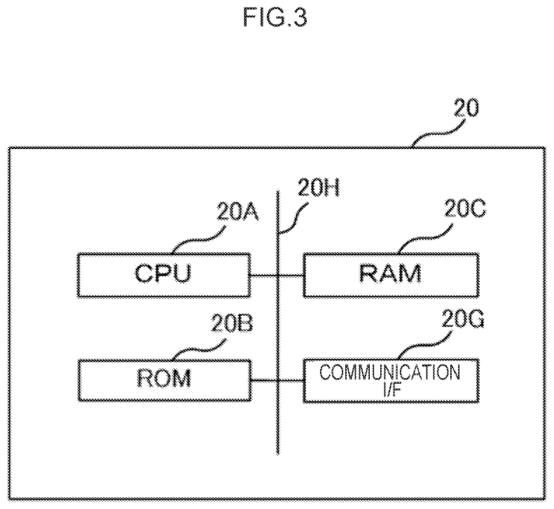

As illustrated in FIG. 3, the center server 20 includes a CPU 20A, ROM 20B, RAM 20C, and a communication I/F 20G. The CPU 20A, the ROM 20B, the RAM 20C, and the communication I/F 20G are connected so as to be capable of communicating with each other via an internal bus 20H.

The CPU 20A is a central processing unit that executes various programs and controls various components. Namely, the CPU 20A reads a program from the ROM 20B, and executes the program using the RAM 20C as a workspace.

The ROM 20B stores various programs and various data. The RAM 20C serves as a workspace to temporarily store programs and data.

The ROM 20B of the present exemplary embodiment stores an information processing program. The information processing program is a program to implement various functions of the center server 20.

The communication I/F 20G is an interface for connecting to the network CN1.

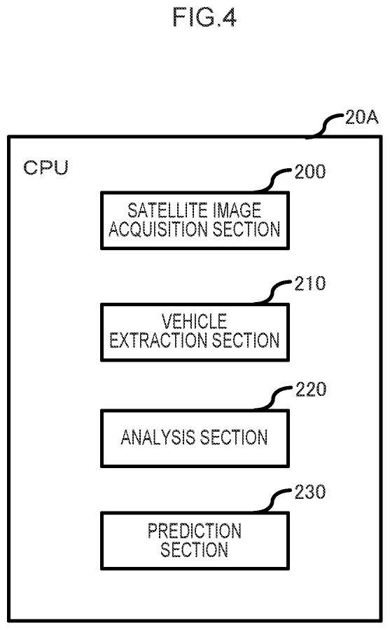

FIG. 4 is a block diagram illustrating an example of a functional configuration of the CPU 20A. As illustrated in FIG. 4, the CPU 20A includes a satellite image acquisition section 200, a vehicle extraction section 210, an analysis section 220, and a prediction section 230. The respective functional configurations are implemented by the CPU 20A reading and executing an information processing program stored in the ROM 20B.

The satellite image acquisition section 200 acquires satellite images from the satellite server 10 via the communication I/F 20G. In the present exemplary embodiment, as an example, the satellite image acquisition section 200 acquires a satellite image captured at a pre-set target location and at a pre-set target date and time. Note that the target location and the target date and time may be predetermined by the user terminal 30, or may be predetermined by an administrator or the like of the center server 20. The target location and the target date and time can be changed via the communication I/F 30G and the communication I/F 20G, for example, by input from the input section 30E of the user terminal 30.

In the present exemplary embodiment, the satellite image acquisition section 200 transmits a pre-set target location, target date, and target time to the satellite server 10. The satellite server 10 then transmits the satellite image captured at the target location, target date, and target time, which is received from the satellite acquisition section 200, to the center server 20. In the present exemplary embodiment, as an example, the target date and time are during the daytime on consecutive days of one week, and as an example, 10:00 a.m. and 2:00 p.m. are set as the target time. As a result, the satellite image acquisition section 200 acquires satellite images of a target location captured at 10:00 a.m. and 2:00 p.m. for consecutive days of one week. Note that the target date and time is not limited to 10:00 a.m. and 2:00 p.m., and the satellite image acquisition section 200 may continuously acquire satellite images captured during the daytime. Moreover, note that in the present exemplary embodiment, as an example, 8:00 a.m. to 3:00 p.m. is defined as the daytime.

The vehicle extraction section 210 extracts large-sized vehicles, which have a size equal to or greater than a predetermined value, from the satellite image. In the present exemplary embodiment, specifically, the vehicle extraction section 210 extracts trucks, buses, and vehicles with a predetermined weight or greater as large-sized vehicles. The extraction of trucks and buses by the vehicle extraction section 210 may be performed, for example, by generating a template in which plural types of trucks and buses are captured from above in advance, and matching this template.

Moreover, as an example of extraction of a vehicle of a predetermined weight or greater by the vehicle extraction section 210, a code such as a two-dimensional code or mark which specifies that a vehicle is a vehicle of a predetermined weight or greater may be disposed at an upper part of a vehicle that may have a predetermined weight or greater, such as a home delivery vehicle, and this code may be extracted from a satellite image so as to extract the vehicle at which the code is disposed, as a vehicle of a predetermined weight or greater. Note that a method for extracting large-sized vehicles from a satellite image is not particularly limited, and known technology can be used.

The analysis section 220 detects, in the satellite image, a road on which travel of large-sized vehicles is equal to or greater than a predetermined value, and analyzes vehicle data for the detected road. More specifically, the analysis section 220 detects, in the satellite image, roads for which a predetermined number or more of large-sized vehicles extracted by the vehicle extraction section 210 have traveled a predetermined road range (for example, 1 km). The analysis section 220 analyzes a classification (for example, a large-sized vehicle, a passenger vehicle, or a light vehicle) of a vehicle traveling on a road detected in a satellite image. Note that known technology can be used to classify the vehicle.

The prediction section 230 predicts a state of deterioration of a surface of a road based on an analysis result obtained by the analysis section 220. More specifically, as an example, for a road on which travel of large-sized vehicles detected by the analysis section 220 is equal to or greater than a predetermined value, the percentage of the traveling vehicles that are large-sized vehicles can be calculated as the degree of deterioration of the surface of the road. Namely, the percentage of large-sized vehicles with respect to all vehicles traveling on a road in the satellite images captured at 10:00 a.m. and 2:00 p.m. on consecutive days for one week is calculated as the degree of deterioration of the surface of the road.

More specifically, as an example, in a case in which all of the traveling vehicles are large-sized vehicles, the degree of deterioration is 100%, and in a case in which 50% of the traveling vehicles are large-sized vehicles, the degree of deterioration is 50%. Note that in the present exemplary embodiment, as an example, the range of the value of the degree of deterioration is set to be in the range of from 0% to 100%; however, the present disclosure is not limited to this, and a degree of deterioration in a different range may be used. The state of deterioration, namely the degree of deterioration of the surface of the road predicted in this manner is output to the user terminal 30 via the communication I/F 20G and the communication I/F 30G.

Moreover, the prediction section 230 may apply a weighting according to the weather, which is based on the weather information associated with the satellite image, to the predicted state of deterioration of the surface of the road. In this case, the satellite image acquisition section 200 acquires weather information associated with the acquired satellite image. More specifically, as an example, in a case in which the prediction section 230 has calculated the degree of deterioration to be 50%, the satellite image acquisition section 200 acquires weather information associated with the satellite image used in this calculation, namely, the satellite image used in detecting the number of large-sized vehicles. Based on the weather information acquired by the satellite image acquisition section 200, for example, in a case in which information indicating clear weather from among the acquired weather information is associated with a satellite image, the degree of deterioration is multiplied by 1 as a weighting factor, in a case in which information indicating cloudy weather is associated with a satellite image, the degree of deterioration is multiplied by 0.8 as a weighting factor, and in a case in which information indicating rainy weather is associated with a satellite image, the degree of deterioration is multiplied by 0.5 as a weighting factor. Note that the values of the weighting factors are not limited to these, and different values may be used. Alternatively, the weighting factors may be modified as appropriate.

Moreover, the prediction section 230 may predict the state of deterioration of a surface of a road by inputting the analysis result analyzed by the analysis section 220 to a state of deterioration prediction model learned using the analysis result by the analysis section 220 and the actual degree of deterioration of the surface of the road as a dataset.

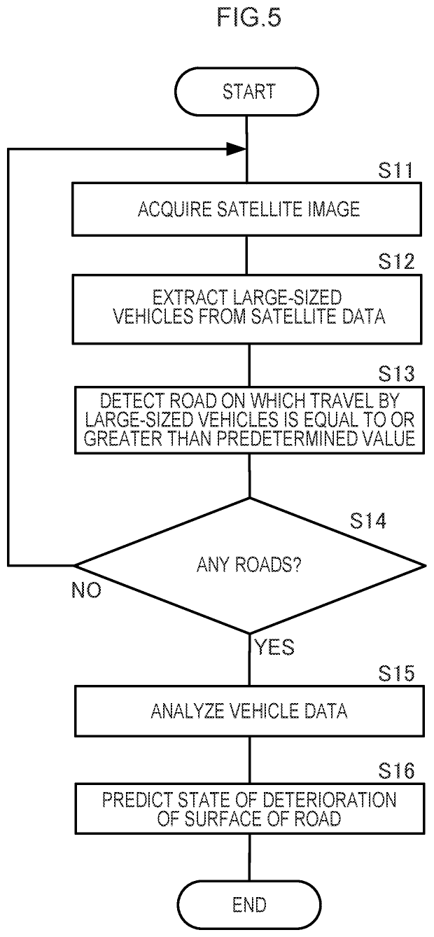

Next, explanation follows regarding a flow of prediction processing that predicts a state of deterioration of a surface of a road, with reference to FIG. 5. The prediction processing is performed by the CPU 20A reading the prediction program from the ROM 20B, and loading and executing the program in the RAM 20C. Note that the satellite server 10 sequentially acquires and accumulates satellite data.

As illustrated in FIG. 5, first, at step S11, the satellite image acquisition section 200 acquires a satellite image as described above. Next, at step S12, the vehicle extraction section 210 extracts large-sized vehicles from the satellite image acquired from the satellite server 10 as described above.

At step S13, the analysis section 220 detects a road on which travel of large-sized vehicles is equal to or greater than a predetermined value, as described above. Next, the analysis section 220 determines whether or not there is a detected road. In a case in which there is no detected road (step S14; NO), the analysis section 220 transitions to the processing of step S11.

On the other hand, at step S14, in a case in which there is a detected road (step S14; YES), at step S15, the analysis section 220 analyzes the vehicle data for vehicles traveling on the detected road as described above. Next, at step S16, the prediction section 230 predicts the state of deterioration of the surface of the road based on the analysis result of the analysis section 220 at step S15 as described above, and ends the example processing.

Next, explanation follows regarding the operation and effects of the center server 20 serving as an information processing device in the first exemplary embodiment.

The center server 20 of the first exemplary embodiment extracts large-sized vehicles, which have a size equal to or greater than a predetermined value, from a satellite image, and detects a road on which travel of the large-sized vehicles is equal to or greater than a predetermined value. This enables the number of large-sized vehicles actually traveling on a road to be understood from the satellite image. Moreover, the center server 20 of the present exemplary embodiment analyzes vehicle data for a road on which the travel of large-sized vehicles is equal to or greater than a predetermined value, and based on the analysis results, predicts a state of deterioration of the surface of the road. As a result, since the state of deterioration of a surface of a road can be predicted based on vehicle data for a road on which the actual travel amount of large-sized vehicles is large, the state of deterioration of the surface of the road can be predicted accurately. Moreover, since the state of deterioration of the surface of the road can be accurately predicted, the infrastructure and life-cycle cost of the road can be optimized, thereby enabling the lifespan of the road to be extended and the budget for the road to be reduced.

Moreover, the center server 20 of the first exemplary embodiment acquires satellite images acquired during a clear-weather day, thereby enabling clearer satellite images to be acquired. As a result, since large-sized vehicles can be easily extracted from the acquired satellite image, the state of deterioration of the surface of the road can be predicted more accurately.

Moreover, for example, a satellite image captured in clear weather has a higher intensity of illumination compared to a satellite image captured in rainy weather or cloudy weather, and therefore, large-sized vehicles are easier to extract than from a satellite image captured in rainy weather or cloudy weather. On the other hand, satellite images captured in rainy weather and cloudy weather have a lower intensity of illumination compared to satellite images captured in clear weather, and therefore, it is more difficult to extract large-sized vehicles than from satellite images captured in clear weather. Accordingly, the center server 20 of the first exemplary embodiment applies a weighting according to the weather based on the weather information associated with the satellite image to the predicted state of deterioration of the surface of the road. This enables the reliability of extraction of large-sized vehicles in the satellite image to be reflected in the predicted state of deterioration of the surface of the road, thereby enabling the state of deterioration of the surface of the road to be predicted more accurately.

Moreover, the center server 20 of the first exemplary embodiment extracts trucks, buses, and vehicles with a predetermined weight or greater as large-sized vehicles. Accordingly, in a case in which a vehicle having a predetermined weight or greater is extracted as a large-sized vehicle, for example, even a vehicle of a relatively small size, a vehicle loaded with more baggage is also extracted as a large-sized vehicle. For this reason, vehicles with heavy weight, which are considered to affect deterioration of a surface of a road, can also be reflected in the prediction of the state of deterioration of the surface of the road.

Next, explanation follows regarding a center server 20-2 serving as an information processing device according to a second exemplary embodiment of the present disclosure. Note that in the present exemplary embodiment, similar configurations to those of the first exemplary embodiment are denoted by the same reference numerals as in the first exemplary embodiment, and detailed explanation thereof is omitted.

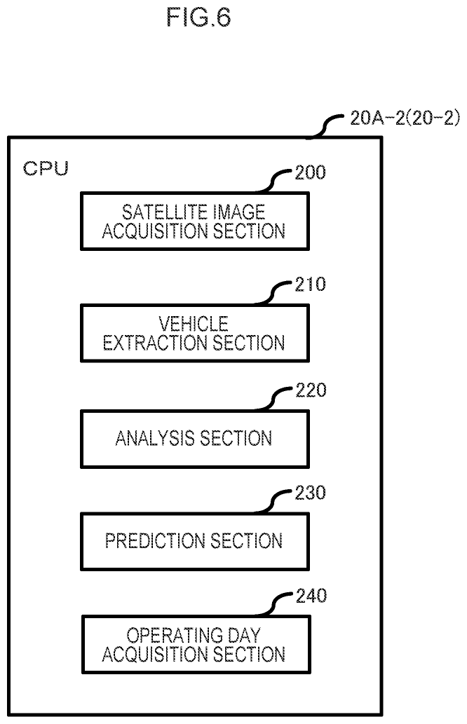

As illustrated in FIG. 6, a CPU 20A-2 of the center server 20-2 of the present exemplary embodiment further includes an operating day acquisition section 240, which is equivalent to the configuration of the CPU 20A of the center server 20 of the first exemplary embodiment.

The operating day acquisition section 240 acquires data indicating the operating days of the relevant business from a business of a delivery company, a construction company, or the like which operate large-sized vehicles. Namely, the operating day acquisition section 240 acquires data indicating the days on which large-sized vehicles actually travel. Moreover, the satellite image acquisition section 200 acquires, from the satellite server 10, a satellite image acquired on an operating day of a business which is included in the data acquired by the operating day acquisition section 240.

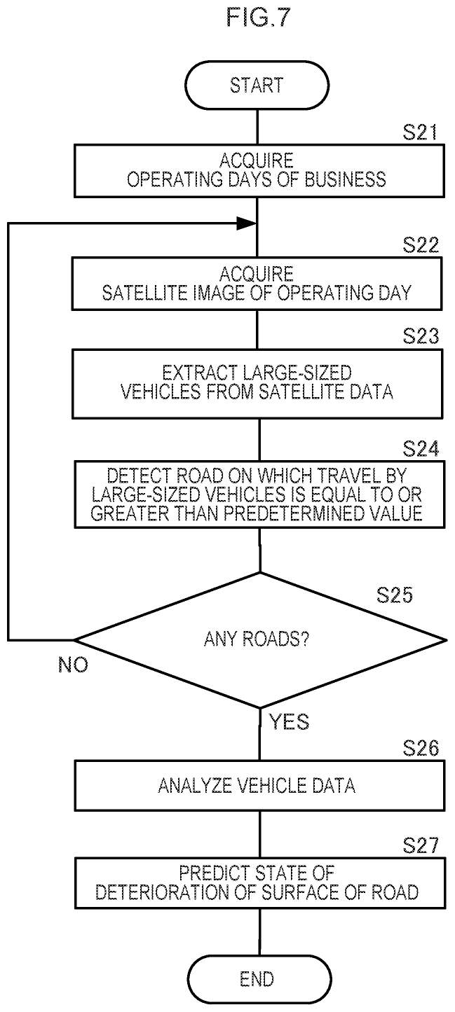

Next, explanation follows regarding a flow of prediction processing that predicts a state of deterioration of a surface of a road, with reference to FIG. 7. The prediction processing is performed by the CPU 20A-2 reading the prediction program from the ROM 20B, and loading and executing the program in the RAM 20C. Note that the satellite server 10 sequentially acquires and accumulates satellite data.

As illustrated in FIG. 7, first, at step S21, the operating day acquisition section 240 acquires data indicating the operating days of a business as described above. Next, at step S22, the satellite image acquisition section 200 acquires the satellite image of the operating day as described above. Note that step S23 to step S27 are similar processing to step S12 to step S16 illustrated in FIG. 5 of the first exemplary embodiment, and therefore detailed explanation thereof is omitted.

Next, explanation follows regarding the operation and effects of the center server 20-2 serving as an information processing device in the second exemplary embodiment.

The center server 20-2 of the second exemplary embodiment acquires satellite images captured on an operating day of a business that operates large-sized vehicles. This enables the satellite image captured on the day on which the large-sized vehicles actually travel to be acquired, enabling the state of deterioration of the surface of the road to be predicted more accurately.

Notes Note that in the above-described exemplary embodiments, the satellite image acquisition section 200 acquires satellite images captured during the daytime, namely at 10:00 a.m. and 2:00 p.m.; however, the present disclosure is not limited to this. For example, in a case in which from 8:00 a.m. to 3:00 p.m. is defined as daytime, a satellite image captured other than during the daytime, at, for example, 4:00 p.m. may be acquired. In this case, the prediction section 230 may further apply a weighting to the predicted state of deterioration of the surface of the road based on the time at which the satellite image was acquired. For example, in a case in which the image is captured during the daytime, the degree of deterioration is multiplied by 1 as a weighting factor, or in a case in which the image is captured other than during the daytime, the degree of deterioration is multiplied by 0.5 as a weighting factor. Note that the values of the weighting factors are not limited to these, and different values may be used. Alternatively, the weighting factors may be modified as appropriate.

Moreover, in the above-described exemplary embodiments, although the vehicle extraction section 210 extracts trucks, buses, and vehicles with a predetermined weight or greater as large-sized vehicles, only trucks and buses may be extracted as large-sized vehicles, or only vehicles with a predetermined weight or greater may be extracted as large-sized vehicles. The vehicles to be extracted as large-sized vehicles can be modified as appropriate.

Although the center server 20 configured separately from the user terminal 30 is applied as the information processing device in the above-described exemplary embodiments, the present disclosure is not limited to this example. A device incorporated in the user terminal 30 may be applied as the information processing device.

Although the satellite images are accumulated in the satellite server 10 which is configured separately from the center server 20 in the above-described exemplary embodiments, the present disclosure is not limited to this example. The satellite images may be accumulated in a storage device such as the ROM 20B or the storage included in the center server 20.

Note that the processing executed by the CPU reading and executing software (a program) in the above-described exemplary embodiments may be executed by various types of processor other than a CPU. Examples of such processors include a Programmable Logic Device (PLD) in which the circuit configuration can be modified post-manufacture, such as a Field-Programmable Gate Array (FPGA), or a specialized electric circuit that is a processor with a specifically-designed circuit configuration for executing specific processing, such as an Application Specific Integrated Circuit (ASIC). Further, the above-described processing may be executed by one of these various types of processors, or may be executed by combining two or more of the same type or different types of processors (for example, plural FPGAs, or a combination of a CPU and an FPGA, or the like). Moreover, a hardware configuration of the various processors is specifically formed as an electric circuit combining circuit elements such as semiconductor elements.

Although explanation has been given regarding an example in which the respective programs are stored (installed) in advance in the ROM in the above-described exemplary embodiments, there is no limitation thereto. The programs may be provided in a format recorded on a recording medium such as compact disc read only memory (CD-ROM), digital versatile disc read only memory (DVD-ROM), or universal serial bus (USB) memory. Alternatively, the programs may be provided in a format downloadable from an external device over a network.

The flow of processing described in the above-described exemplary embodiments is an example, and unnecessary steps may be deleted, new steps may be added, or the processing order may be rearranged within a range not departing from the spirit of the present disclosure.

The configurations of the satellite server 10, the center server 20, and the user terminal 30 described in the above-described exemplary embodiments are examples, and may be modified according to circumstances within a range not departing from the spirit of the present disclosure.

What is claimed is:

1. An information processing device comprising at least one processor, wherein
the at least one processor is configured to:
acquire a satellite image;
extract large-sized vehicles, which have a size equal to or greater than a predetermined value, from the satellite image;
detect, in the satellite image, a road on which travel of the large-sized vehicles is equal to or greater than a predetermined value, and to analyze vehicle data for the road; and
predict a state of deterioration of a surface of the road based on an analysis result.

2. The information processing device according to claim 1, wherein:
the at least one processor is configured to acquire weather information associated with the acquired satellite image; and
based on the acquired weather information, the at least one processor is configured to acquire a satellite image captured on a clear-weather day.

3. The information processing device according to claim 1, wherein:
the at least one processor is configured to acquire weather information associated with the acquired satellite image; and
the at least one processor is configured to apply, to a predicted state of deterioration of the surface of the road, a weighting according to weather based on the weather information.

4. The information processing device according to claim 1, wherein:
the at least one processor is configured to extract, as the large-sized vehicles, at least one of trucks, buses, or vehicles having a predetermined weight or greater.

5. The information processing device according to claim 1, wherein:
the at least one processor is further configured to acquire, from a business that operates large-sized vehicles, data indicating operating days of the business; and
the at least one processor is configured to acquire a satellite image captured on an operating day of the business which is included in the data.
